(19) United States
(12) Patent Application Publication
(10) Pub. No.: US 2008/0007983 A1
(43) Pub. Date: Jan. 10, 2008

(54) Frequency-to-voltage converter with analog multiplication

(75) Inventor: Jeff C. Klein, Tucson, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/478,174

(22) Filed: Jun. 28, 2006

(51) Int. Cl. F21V 33/00

(52) U.S. Cl. 363/122

(57) ABSTRACT

A circuit and method are provided for supplying a DC output signal having a magnitude that is proportional to the mathematical product of a variable frequency AC signal and a variable magnitude DC signal. The method implemented by the circuit includes converting the variable frequency AC signal to a first intermediate AC signal that is a fixed pulse-width, variable period signal having a duty cycle representative of the frequency of the AC signal, and having an amplitude that varies between a first voltage magnitude and a second voltage magnitude. The first intermediate AC signal is converted to a second intermediate AC signal by setting the first intermediate AC signal amplitude equal to a third voltage magnitude when the intermediate signal amplitude is equal to the first voltage magnitude, and equal to a fourth voltage magnitude when the intermediate signal amplitude is equal to the second voltage magnitude. The second intermediate AC signal is filtered to thereby convert it to the DC voltage signal.

### STATEMENT REGARDING FEDERALLY SPONSORED RESEARCH OR DEVELOPMENT

This invention was made with Government support under contract number 33657-99-D-2050 awarded by the U.S. Air Force. The Government has certain rights in this invention.

### TECHNICAL FIELD

The present invention relates to analog signal processing and, more particularly, to a circuit and method for supplying a DC output signal having a magnitude that is proportional to the mathematical product of a variable frequency AC signal and a variable magnitude DC signal.

### BACKGROUND

Various circuits and systems receive variable frequency AC signals and one or more other time-variable signals and supply an output signal based on these time-variant input signals. For example, some engine controllers include analog electronics that receive an engine speed signal that is a variable frequency AC signal representative of engine speed (Fᵢₙ(t)), and a temperature signal having a DC voltage magnitude that varies with a temperature within the engine (Vᵢₙ(t)). The overall function of the analog electronics is to supply a DC output signal (Vₒᵤₜ(t)) that is proportional to the mathematical product of the AC signal frequency and the DC voltage magnitude (e.g., Vₒᵤₜ(t)=k×Fᵢₙ(t)×Vᵢₙ(t)).

Currently, the analog electronics in these engine controllers first converts the variable frequency AC signal into an intermediate DC signal having a magnitude proportional to the AC signal frequency. The electronics then implements a multiplier function that multiplies the intermediate DC signal by the proportionality constant (k) and the variable magnitude DC voltage signal to produce the desired DC output signal. Although the presently used electronics and methodology works well, and is generally safe and robust, it does present certain drawbacks. Namely, it can rely on an inordinate number of circuit components and/or on relatively complex circuitry.

Hence, there is a need for an analog circuit and method for supplying a DC output signal having a magnitude that is proportional to the mathematical product of a variable frequency AC signal and a variable magnitude DC signal, and that does not rely on an inordinate number of circuit components and/or on relatively complex circuitry. The present invention addresses at least this need.

### BRIEF SUMMARY

The present invention provides a circuit and method for supplying a DC output signal having a magnitude that is proportional to the mathematical product of a variable frequency AC signal and a variable magnitude DC signal. In one embodiment, and by way of example only, a method of converting a variable frequency AC signal to a DC voltage signal includes converting the variable frequency AC signal to a first intermediate AC signal that is a fixed pulse-width, variable period signal having a duty cycle representative of the frequency of the AC signal, and having an amplitude that varies between a first voltage magnitude and a second voltage magnitude. The first intermediate AC signal is converted to a second intermediate AC signal by setting the first intermediate AC signal amplitude equal to a third voltage magnitude when the intermediate signal amplitude is equal to the first voltage magnitude, and equal to a fourth voltage magnitude when the intermediate signal amplitude is equal to the second voltage magnitude. The second intermediate AC signal is filtered to thereby convert it to the DC voltage signal.

In another exemplary embodiment, a frequency-to-voltage (F/V) converter and multiplier includes a pulse generator, a pulse converter, and a low-pass filter. The pulse generator is coupled to receive a variable frequency AC signal and is configured, upon receipt thereof, to convert the variable frequency AC signal to a first intermediate AC signal. The first intermediate AC signal being a fixed pulse-width, variable period signal having a duty cycle representative of the frequency of the AC signal, and having an amplitude that varies between a first voltage magnitude and a second voltage magnitude. The pulse converter is coupled to receive the first intermediate AC signal and a variable magnitude DC input signal and is configured, upon receipt thereof, to convert the first intermediate AC signal to a second intermediate AC signal by setting the first intermediate AC signal amplitude equal to the magnitude of the DC input signal when the first intermediate AC signal amplitude is equal to the first voltage magnitude, and to a reference voltage magnitude when the first intermediate AC signal amplitude is equal to the second voltage magnitude. The low-pass filter is coupled to receive the second intermediate AC signal and is configured, upon receipt thereof, to convert the second intermediate AC signal to a DC output signal.

In yet another exemplary embodiment, an engine controller for a gas turbine engine includes a speed sensor, a temperature sensor, and a frequency-to-voltage converter and multiplier circuit. The speed sensor is configured to sense a rotational speed of a component in the gas turbine engine and supply an AC engine speed signal having a frequency that varies with the sensed rotational speed of the component. The temperature sensor is configured to sense a temperature within the gas turbine engine and supply a DC temperature signal having a voltage magnitude that varies with the sensed temperature. The frequency-to-voltage (F/V) converter and multiplier circuit is coupled to receive the AC engine speed signal and the DC temperature signal and is operable, upon receipt thereof, to supply a DC output signal proportional to a mathematical product of the AC engine speed signal frequency and the DC temperature signal voltage magnitude. The F/V converter and multiplier circuit includes a pulse generator, a pulse converter, and a low-pass filter. The pulse generator is coupled to receive the AC engine speed signal and is configured, upon receipt thereof, to convert the AC engine speed signal to a first intermediate AC signal. The first intermediate AC signal being a fixed pulse-width, variable period signal having a duty cycle representative of the frequency of the AC engine speed signal, and having an amplitude that varies between a first voltage magnitude and a second voltage magnitude. The pulse converter is coupled to receive the first intermediate AC signal and is configured, upon receipt thereof, to convert the first intermediate AC signal to a second intermediate AC signal by setting the first intermediate AC signal amplitude equal to the DC temperature signal voltage magnitude when the intermediate signal amplitude is equal to the first voltage magnitude, and to a reference voltage magnitude when the first intermediate AC signal amplitude is equal to the second voltage magnitude. The low-pass filter is coupled to receive the second intermediate AC signal and is configured, upon receipt thereof, to convert the second intermediate AC signal to the DC output signal.

Other independent features and advantages of the preferred circuit and method will become apparent from the following detailed description, taken in conjunction with the accompanying drawings which illustrate, by way of example, the principles of the invention.

### BRIEF DESCRIPTION OF THE DRAWINGS

FIG. 1 is a block diagram of an exemplary engine and exemplary engine controller that may used to implement various embodiments of the present invention;

FIG. 2 is a block diagram of an analog frequency-to-voltage (F/V) converter and multiplier circuit according to an exemplary first embodiment of the present invention that may be used in the engine controller of FIG. 1; and

FIG. 3 is a block diagram of an analog frequency-to-voltage (F/V) converter and multiplier circuit according to an exemplary second embodiment of the present invention that may be used in the engine controller of FIG. 1.

### DETAILED DESCRIPTION OF PREFERRED EMBODIMENTS

The following detailed description of the invention is merely exemplary in nature and is not intended to limit the invention or the application and uses of the invention. Furthermore, there is no intention to be bound by any theory presented in the preceding background of the invention or the following detailed description of the invention. In this regard, although the circuit and method are described as being implemented in an engine controller, it will be appreciated that the circuit and method may be implemented in other systems and circuits. Moreover, although the circuit and method are described as processing a variable frequency speed signal and a variable magnitude temperature signal, it will be appreciated that the circuit and method may be used to process any one of numerous other signals.

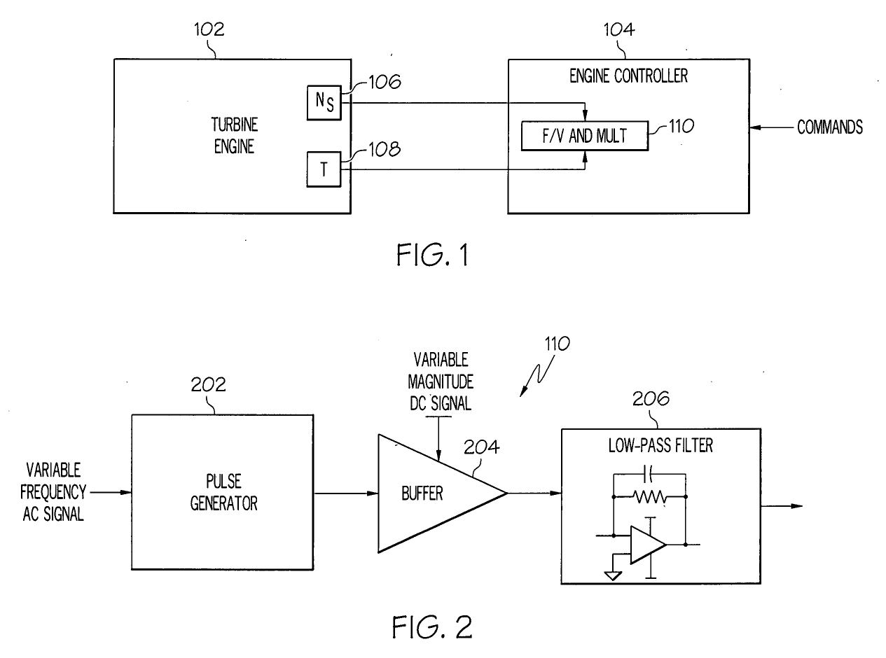

Turning now to FIG. 1, an exemplary embodiment of an engine 102 and engine controller 104 are depicted in functional block diagram form. The engine 102 is preferably a gas turbine engine that includes one or more compressors, a combustor, and one or more turbines. These components are conventional, and as such are not depicted and will not be further described. The engine controller 104 receives command signals and various signals representative of engine operation and, in response to these signals, controls the operation of the engine 102.

The signals representative of engine operation that are supplied to the engine controller 104 may vary. In the depicted embodiment, only two signals are illustrated—a speed signal and a temperature signal. The speed signal is supplied from a speed sensor 106, and the temperature signal is supplied from a temperature sensor 108. The speed sensor 106 may be any one of numerous types of devices that are configured to sense the rotational speed of a component within the engine 102 and supply an AC signal having a frequency representative of the sensed rotational speed. Similarly, the temperature sensor 108 may be any one of numerous types of devices that are configured to sense a temperature within the engine and supply a DC signal having a voltage magnitude representative of the sensed temperature.

No matter the specific type of sensors that are used to implement the speed sensor 106 and the temperature sensor 108, it will be appreciated that, because the parameters each sensor is sensing may be time-variant, the signals supplied from each sensor 106, 108 may concomitantly be time-variant. In particular, the speed signal supplied from the speed sensor 106 may be a variable frequency AC engine speed signal, and the temperature signal supplied from the temperature sensor 108 may be a variable magnitude DC temperature signal.

Before proceeding further, it is noted that the engine controller 104 may, and in many instances will, receive more than just a speed signal and a temperature signal. However, these are the only signals that are needed to fully describe and enable various embodiments of the instant invention, and as such these are the only two depicted and described. It is additionally noted that the speed sensor 106 may be configured to sense the rotational speed of any one of numerous components within the engine 102, and the temperature sensor 108 may be configured to sense the temperature at any one of numerous locations within the engine 102. Moreover, speed and temperature are merely exemplary of the types of variable frequency AC signals and variable magnitude DC signals that could be supplied to and processed in the engine controller 104.

Returning now to the description, no matter the specific speed or temperature that is being sensed, it is seen in FIG. 1 that the variable frequency AC engine speed signal and variable magnitude DC temperature signal are processed in the engine controller by at least a frequency-to-voltage (F/V) converter and multiplier circuit 110. In particular, the F/V converter and multiplier circuit 110, in response to these signals, supplies a DC output signal (Vₒᵤₜ(t)) that is proportional to the mathematical product of the AC engine speed signal frequency (Fᵢₙ(t)) and the DC temperature signal voltage magnitude (Vᵢₙ(t)) (e.g., Vₒᵤₜ(t)=k×Fᵢₙ(t)×Vᵢₙ(t)).

The DC output signal supplied from the F/V and multiplier circuit 110 may be used within the engine controller 104 to implement various functions, none of which are needed to fully describe or enable the instant invention. Thus, the end use of the DC output signal will not be further described. However, with reference now to FIG. 2, the F/V converter and multiplier circuit 110, according to a first exemplary embodiment, will now be described.

The F/V converter and multiplier circuit 110 includes a pulse generator 202, a pulse converter 204, and a low-pass filter 206. The pulse generator 202, which is preferably implemented as a re-triggerable, fixed-width pulse generator, receives the AC engine speed signal and supplies a fixed pulse-width, variable period signal having a duty cycle representative of the frequency of the AC engine speed signal. This fixed pulse-width, variable period signal, which is referred to herein as a first intermediate AC signal, varies in amplitude between a first voltage magnitude and a second voltage magnitude. It will be appreciated that the specific values of the first and second voltage magnitude may vary, but in a particular preferred embodiment the first voltage magnitude is a non-reference value, and the second voltage magnitude is a reference (or ground) voltage value. Moreover, the pulse generator 202 is configured such that the pulse width is equal to the proportionality constant (k) in the above described mathematical product. In a particular preferred embodiment, the proportionality constant (k) is equal to the reciprocal of the maximum frequency (F_{MAX}) at which the AC engine speed signal is expected to be supplied (e.g., k=1/F_{MAX}).

The pulse converter 204 receives the first intermediate AC signal supplied from the pulse generator 202 and converts this signal to a second intermediate AC signal. In particular, and as FIG. 2 depicts, the pulse converter 204 additionally receives the DC temperature signal and is configured to set the first intermediate AC signal amplitude equal to the DC temperature signal voltage magnitude when the first intermediate AC signal amplitude is equal to the first voltage magnitude, and to set the first intermediate AC signal amplitude equal to the reference voltage magnitude when the first intermediate AC signal amplitude is equal to the second voltage magnitude. It will be appreciated that the pulse converter 204 may be implemented using any one of numerous circuits to carry out its functionality. In the embodiment depicted in FIG. 2, the pulse converter 204 is implemented using a conventional buffer amplifier, in which the DC temperature signal is coupled to the amplifier power supply input (or so-called “rail voltage” input). However, in an alternative embodiment, which is described in more detail further below, the pulse converter 204 is implemented using a plurality of analog switches.

The low-pass filter 206 receives the second intermediate AC signal that is supplied from the pulse converter 204, and filters out the DC output signal. It will be appreciated that the low-pass filter 206 may be implemented using any one of numerous known low-pass filter circuit configurations for filtering out a DC component from an AC signal. For example, and as shown in FIG. 2, the low-pass filter 206 could be implemented using the well-known first-order, active low-pass filter/integrator circuit. In any case, the low-pass filter 206 is implemented with circuit components such that the instantaneous amplitude of the DC output signal (Vₒᵤₜ) that is supplied therefrom is equal to the product of the proportionality constant (k), the instantaneous frequency of the AC engine speed signal (Fᵢₙ), and the instantaneous amplitude of the DC temperature signal (Vᵢₙ), when the AC engine speed signal frequency is less than F_{MAX}. When, however, the AC engine speed signal frequency is greater than or equal to maximum frequency (F_{MAX}), the instantaneous amplitude of the DC output signal (Vₒᵤₜ) that is supplied from the low-pass filter 206 is equal to the instantaneous amplitude of the DC temperature signal (Vᵢₙ).

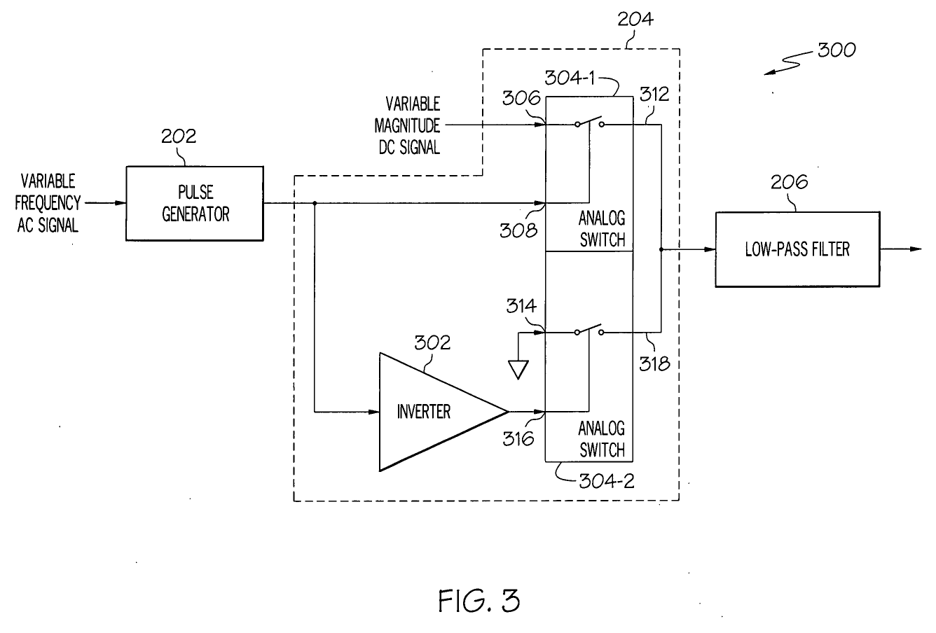

Turning now to FIG. 3, an alternative F/V converter and multiplier circuit 300 is depicted and includes the pulse generator 202, the pulse converter 204, and the low-pass filter 206. The pulse generator 202 and low-pass filter 206 in this alternative embodiment preferably function at least substantially identical to the pulse generator 202 and low-pass filter 206 described above and depicted in FIG. 2. As such, these portions of the F/V converter and multiplier circuit 300 depicted in FIG. 3 will not be described. It is further noted that although the pulse converter circuit 204 depicted in FIG. 3 is implemented differently from that depicted in FIG. 2, its overall function is the same.

With the above background in mind, it is seen that the pulse converter 204 depicted in FIG. 3 includes an inverter 302, and a pair of analog switches 304—a first analog switch 304-1, and a second analog switch 304-2. The inverter 302 is coupled to receive the first intermediate AC signal supplied from the pulse generator 202, and supplies an inverted first intermediate AC signal to one of the analog switches. In particular, the inverted first intermediate AC signal is supplied to the second analog switch 304-2, which is described below, after the following description of the first analog switch 304-1.

The first analog switch 304-1 includes at least a first input 306, a second input 308, and an output 312. The first analog switch first input 306 is coupled to receive the DC temperature signal supplied from the temperature sensor, the first analog switch second input 308 is coupled to receive the first intermediate AC signal supplied from the pulse generator 202, and the first analog switch output 312 is coupled to the low-pass filter 206. The first analog switch 304-1 is configured to be responsive to the signal on its second input 308. That is, the first analog switch 304-1 is responsive to the signal on its second input 308 to move between an open position and a closed position. In the open position, which is the position depicted in FIG. 3, the first analog switch first input 306 is electrically isolated from the first analog switch output 312. Conversely, in the closed position the first analog switch first input 306 is electrically coupled to the first analog switch output 312. In a particular preferred embodiment, when the first intermediate AC signal is at the first amplitude (e.g., the non-reference value), the first analog switch 304-1 is closed, and when the first intermediate AC signal is at the second amplitude (e.g., the reference value), the first analog switch 304-1 is open.

The second analog switch 304-2 is at least substantially identical to the first analog switch 304-1, and thus includes a first input 314, a second input 316, and an output 318. The second analog switch first input 314 is coupled to the reference potential (e.g., ground), and the second analog switch second input 316 is coupled to receive the inverted first intermediate AC signal supplied from the inverter 302. The second analog switch output 318 is coupled to the first analog switch output 312 and the low-pass filter 206. The second analog switch 304-2, similar to the first analog switch 304-1, is responsive to the signal on its second input 314 to move between an open position and a closed position. Also similar to the first analog switch 304-1, when the second analog switch 304-2 is in the open position, which is the position depicted in FIG. 3, its first input 314 is electrically isolated from its output 318, and when the second analog switch 304-2 is in the closed position its first input 314 is electrically coupled to its output 318. In a particular preferred embodiment, when the inverted first intermediate AC signal is at the first amplitude (e.g., the non-reference value), the second analog switch 304-2 is closed, and when the inverted first intermediate AC signal is at the second amplitude (e.g., the reference value), the second analog switch 304-2 is open.

With the above-described pulse converter 204 configuration, it may thus be understood that, due to the inverter 302, whenever the first analog switch 304-1 is closed, the second analog switch 304-2 will be open, and vice-versa. Thus, the pulse converter 204 in the second embodiment 300, like that of the first, will supply the second intermediate AC signal to the low-pass filter 206 by equivalently setting the first intermediate AC signal amplitude equal to the DC temperature signal voltage magnitude when the first intermediate AC signal amplitude is equal to the first voltage magnitude, and to the reference voltage magnitude when the first intermediate AC signal amplitude is equal to the second voltage magnitude.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A method of converting a variable frequency AC signal to a DC voltage signal, comprising the steps of:
converting the variable frequency AC signal to a first intermediate AC signal, the first intermediate AC signal being a fixed pulse-width, variable period signal having a duty cycle representative of the frequency of the AC signal, and having an amplitude that varies between a first voltage magnitude and a second voltage magnitude;
converting the first intermediate AC signal to a second intermediate AC signal by setting the first intermediate AC signal amplitude equal to (i) a third voltage magnitude when the intermediate signal amplitude is equal to the first voltage magnitude and (ii) a fourth voltage magnitude when the intermediate signal amplitude is equal to the second voltage magnitude; and
filtering the second intermediate AC signal to thereby convert it to the DC voltage signal.

2. The method of claim 1, wherein the third voltage magnitude is a variable voltage magnitude.

3. The method of claim 1, wherein the fourth voltage magnitude is at least substantially equal to the second voltage magnitude.

4. The method of claim 3, wherein the second voltage magnitude is a reference potential.

5. The method of claim 1, wherein:
the variable frequency AC signal has an instantaneous frequency value; and
the DC voltage signal has an instantaneous DC voltage magnitude at least substantially equal to a mathematical product of the instantaneous frequency value, the third voltage magnitude, and a constant value (K).

6. The method of claim 5, wherein the fixed-pulse width is at least representative of the constant value.

7. The method of claim 6, wherein:
the instantaneous DC voltage magnitude is at least substantially equal to the mathematical product when the instantaneous frequency value is less than 1/K; and
the instantaneous DC voltage magnitude is at least substantially equal to the third voltage magnitude when the instantaneous frequency value is greater than or equal to 1/K.

8. The method of claim 1, wherein the variable frequency AC signal is a signal representative of a rotational speed of a component.

9. The method of claim 1, wherein the third voltage magnitude is a variable voltage magnitude representative of a temperature of a component or an environment.

10. A frequency-to-voltage (F/V) converter and multiplier circuit, comprising:
a pulse generator coupled to receive a variable frequency AC signal and configured, upon receipt thereof, to convert the variable frequency AC signal to a first intermediate AC signal, the first intermediate AC signal being a fixed pulse-width, variable period signal having a duty cycle representative of the frequency of the AC signal, and having an amplitude that varies between a first voltage magnitude and a second voltage magnitude;
a pulse converter coupled to receive the first intermediate AC signal and a variable magnitude DC input signal and configured, upon receipt thereof, to convert the first intermediate AC signal to a second intermediate AC signal by setting the first intermediate AC signal amplitude equal to (i) the magnitude of the DC input signal when the first intermediate AC signal amplitude is equal to the first voltage magnitude and (ii) a reference voltage magnitude when the first intermediate AC signal amplitude is equal to the second voltage magnitude; and
a low-pass filter coupled to receive the second intermediate AC signal and configured, upon receipt thereof, to convert the second intermediate AC signal to a DC output signal.

11. The circuit of claim 10, wherein:
the variable frequency AC signal has an instantaneous frequency value;
the variable magnitude DC input signal has an instantaneous DC voltage value; and
the DC output signal has an instantaneous DC voltage magnitude at least substantially equal to a mathematical product of the instantaneous frequency value, the instantaneous DC voltage value, and a constant value (K).

12. The circuit of claim 10, wherein the pulse converter comprises a buffer amplifier.

13. The circuit of claim 10, wherein the pulse converter comprises:
a first analog switch including at least a first input, a second input, and an output, the first analog switch first input coupled to receive the variable magnitude DC input signal, the first analog switch second input coupled to receive the first intermediate AC signal, the first analog switch responsive to the second intermediate AC signal to selectively move between (i) an open position, in which the first analog switch output is electrically isolated from first analog switch input and (ii) a closed position, in which the first analog switch output is electrically coupled to the first analog switch input;
an inverter coupled to receive the first intermediate AC signal and configured, upon receipt thereof, to supply an inverted first intermediate AC signal; and
a second analog switch including at least a first input, a second input, and an output, the second analog switch first input coupled to the reference voltage potential, the second analog switch second input coupled to receive the inverted first intermediate AC signal, the second analog switch responsive to the inverted first intermediate AC signal to selectively move between (i) an open position, in which the second analog switch output is electrically isolated from second analog switch input and (ii) a closed position, in which the second analog switch output is electrically coupled to the second analog switch input.

14. The circuit of claim 10, further comprising:
a speed sensor configured to sense a rotational speed of a component and supply the variable frequency AC signal.

15. The circuit of claim 10, further comprising:
a temperature sensor configured to sense temperature within a device and supply the variable magnitude DC input signal.

16. An engine controller for a gas turbine engine, comprising:
a speed sensor configured sense a rotational speed of a component in the gas turbine engine and supply an AC engine speed signal having a frequency that varies with the sensed rotational speed of the component;
a temperature sensor configured to sense temperature within the gas turbine engine and supply a DC temperature signal having a voltage magnitude that varies with the sensed temperature; and
a frequency-to-voltage (F/V) converter circuit coupled to receive the AC engine speed signal and the DC temperature signal and operable, upon receipt thereof, to supply a DC output signal proportional to a mathematical product of the AC engine speed signal frequency and the DC temperature signal voltage magnitude, the F/V converter including:
a pulse generator coupled to receive the AC engine speed signal and configured, upon receipt thereof, to convert the AC engine speed signal to a first intermediate AC signal, the first intermediate AC signal being a fixed pulse-width, variable period signal having a duty cycle representative of the frequency of the AC engine speed signal, and having an amplitude that varies between a first voltage magnitude and a second voltage magnitude,
a pulse converter coupled to receive the first intermediate AC signal and configured, upon receipt thereof, to convert the first intermediate AC signal to a second intermediate AC signal by setting the first intermediate AC signal amplitude equal to (i) the DC temperature signal voltage magnitude when the intermediate signal amplitude is equal to the first voltage magnitude and (ii) a reference voltage magnitude when the first intermediate AC signal amplitude is equal to the second voltage magnitude, and
a low-pass filter coupled to receive the second intermediate AC signal and configured, upon receipt thereof, to convert the second intermediate AC signal to the DC output signal.

17. The controller of claim 16, wherein the pulse converter comprises a buffer amplifier.

18. The controller of claim 16, wherein the pulse converter comprises:
a first analog switch including at least a first input, a second input, and an output, the first analog switch first input coupled to receive the variable magnitude DC temperature signal, the first analog switch second input coupled to receive the first intermediate AC signal, the first analog switch responsive to the second intermediate AC signal to selectively move between (i) an open position, in which the first analog switch output is electrically isolated from first analog switch input and (ii) a closed position, in which the first analog switch output is electrically coupled to the first analog switch input;
an inverter coupled to receive the second intermediate AC signal and configured, upon receipt thereof, to supply an inverted first intermediate AC signal; and
a second analog switch including at least a first input, a second input, and an output, the second analog switch first input coupled to the reference voltage potential, the second analog switch second input coupled to receive the inverted first intermediate AC signal, the second analog switch responsive to the inverted first intermediate AC signal to selectively move between (i) an open position, in which the second analog switch output is electrically isolated from second analog switch input and (ii) a closed position, in which the second analog switch output is electrically coupled to the second analog switch input.

19. The controller of claim 16, wherein:
the variable frequency AC signal has an instantaneous frequency value;
the variable magnitude DC temperatures signal has an instantaneous DC voltage value; and
the DC output signal has an instantaneous DC voltage magnitude at least substantially equal to a mathematical product of the instantaneous frequency value, the instantaneous DC voltage value, and a constant value (K).
